(19) United States
(12) Patent Application Publication
(10) Pub. No.: US 2017/0031771 A1
(43) Pub. Date: Feb. 2, 2017

(54) Dynamically Growing and Shrinking Snapshot Repositories Without Impacting Performance or Latency

(71) Applicant: NetApp, Inc., Sunnyvale, CA (US)

(72) Inventors: Charles Binford, Wichita, KS (US); Mahmoud Jibbe, Wichita, KS (US); Martin Parrish, Wichita, KS (US)

(21) Appl. No.: 14/813,832

(22) Filed: Jul. 30, 2015

(51) Int. Cl. G06F 11/14

(52) U.S. Cl. CPC G06F 11/1451; G06F 2201/84

(57) ABSTRACT

A system, method, and computer program product for the provision of a snapshot repository that grows and shrinks over time. The snapshot repository stores snapshot images. When the used capacity of the repository reaches an upper bound of the repository, the image may be wrapped to the start of the repository if the image stored there previously has been deleted. Otherwise another stripe volume is added from a pool of available volumes and the image continues storage there. As older images are deleted according to a retention policy, stripe volumes that become empty may be dis-associated from their associated LBA range and released to the pool or re-mapped to a lower LBA range of the repository. When the empty stripe volume is at the end of the repository, the ending LBA may be adjusted to the end of the last allocated stripe volume as the volume is released.

### TECHNICAL FIELD

The present description relates to data storage and, more specifically, to systems, methods, and machine-readable media for growing and shrinking a snapshot repository on a dynamic disk pool.

### BACKGROUND

In many data storage systems, data is periodically backed up so that the backed up data may be used in the event of a loss of data at the source. One such way to accomplish this is with copy-on-write snapshots. A snapshot may contain data that represents what occurred during a specified time frame, such as a portion of a day. When a write is directed to a block of a base volume, a copy-on-write snapshot copies the targeted block of data before the write occurs. The targeted block of data is copied and may be stored to another, separate volume (e.g., a repository) for data recovery/rollback purposes. Once the targeted block is copied at the particular point in time, the write to the targeted block may then proceed and overwrite the targeted block with the new write data. Snapshots may be periodically taken indefinitely (e.g., over an indefinite number of periods). This leads to more and more snapshots being saved to the system's repository, which takes up more and more storage space in the repository.

Typically a system's repository for copy-on-write snapshots is limited in size, for example to a small percentage of each base volume for which snapshots are taken. A user of the system may impose a minimum snapshot history, a minimum number of snapshot images to be stored in the repository at any given time. The size may be set manually at the time of initialization of the repository, and expansion may only be achieved by manually adding another volume (range of logical block addresses (LBAs)) to the repository. Further, copy-on-write snapshot systems typically include an automatic purge feature that purges “older” snapshot images when large amounts of data in new snapshot images are added. In these scenarios, the snapshot repository may be at risk of either expanding to consume too much (or all) spare capacity or purging so many older snapshot images that the minimum snapshot history is no longer kept (e.g., where 5 images are required to be kept as history, and the system automatically purges 4 of the older ones to make room for an occasional surge in writes, such as a report that generates a large amount of data) or lost completely.

Accordingly, the potential remains for improvements that, for example, harness features available to dynamic disk pools that may result in an elastic snapshot repository that may automatically grow within specified bounds and also shrink after occasional large-capacity demands come and go.

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2A is an organizational diagram that illustrates the utilization of a snapshot repository according to aspects of the present disclosure.

FIG. 2B is an organizational diagram that illustrates the growing of a snapshot repository according to aspects of the present disclosure.

FIG. 3A is an organizational diagram that illustrates the treatment of specific volumes of a snapshot repository according to aspects of the present disclosure.

FIG. 3B is an organizational diagram that illustrates the treatment of specific volumes of a snapshot repository according to aspects of the present disclosure.

FIG. 4 is an organizational diagram that illustrates the shrinking of a snapshot repository according to aspects of the present disclosure.

FIG. 5 is a flow diagram of a method of growing and maintaining an elastic snapshot repository according to aspects of the present disclosure.

FIG. 6 is a flow diagram of a method of handling specific volumes of an elastic snapshot repository according to aspects of the present disclosure.

FIG. 7 is a flow diagram of a method of shrinking an elastic snapshot repository according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for the dynamic growing and shrinking of a snapshot repository in a dynamic disk pool without impacting performance or latency. The techniques described herein enable a copy-on-write snapshot repository to dynamically grow and shrink in response to varying levels of data writes during different time periods. In an example, a snapshot repository is started for a corresponding base volume with a particular size (e.g., a fixed size or a percentage of the corresponding base volume it is backing up). The snapshot repository may be specified to have a minimum number of volumes (data stripes of a dynamic disk pool). As snapshot images are created in the snapshot repository and grow over time in response to write activity to the base volume, the size of one or more snapshot images may be larger than anticipated or predicted. This may occur, for example, due to unique circumstances where more writes than anticipated are triggered, such as in response to a request to run a report that generates much more data than typically is the case.

In response to the used capacity nearing an upper limit of overall virtual capacity of the snapshot repository, the snapshot image may split the image as it continues growing to wrap it around to a beginning logical block address range of the repository if it is available. If not available, one or more additional volumes may be added to the ending logical block address of the snapshot repository during operation. These additional volumes may be drawn from a pool of available, already-initialized volumes that have not been assigned elsewhere.

Further, in situations where the snapshot image has been wrapped to the start of the repository, as additional snapshot images are added and grow, the growing snapshot image may be split if it would otherwise purge an older, but still active, snapshot image so that a first portion is stored at the current logical block address range up to the starting logical block address of the older but still active snapshot image, and a second portion is stored at a newly added logical block address range added at the end of the snapshot repository.

As older snapshot images become unnecessary due to a minimum number of newer snapshot images having been added, they may be deleted. When this occurs at the start of the snapshot repository, this enables the system to wrap the current snapshot image to continue growing at the starting range. When this occurs in the middle of the repository (e.g., there are active snapshot images at logical block addresses below and above the current location), and deletion of the snapshot image renders the stripe volume empty, then the system may unmap the empty stripe volume and release it back to a pool of available stripe volumes. If there are logical block address ranges below the current range that have been unmapped previously, and the number of stripe volumes is at a minimum, then the stripe volume may be remapped to the lowest logical block address range that is currently unmapped.

When an empty stripe volume is at the end of the logical block address range of the repository, then the system may both unmap (or remap) the stripe volume and adjust the last logical block address to the end of the last allocated (mapped) stripe volume, in effect trimming the overall logical block address range to a smaller size. As time progresses, the snapshot repository may again grow as more snapshot images are added, according to embodiments of the present disclosure that are discussed in more detail below. As a result, the snapshot repository may dynamically grow and shrink over time in a manner that takes advantage of various features of dynamic disk pools.

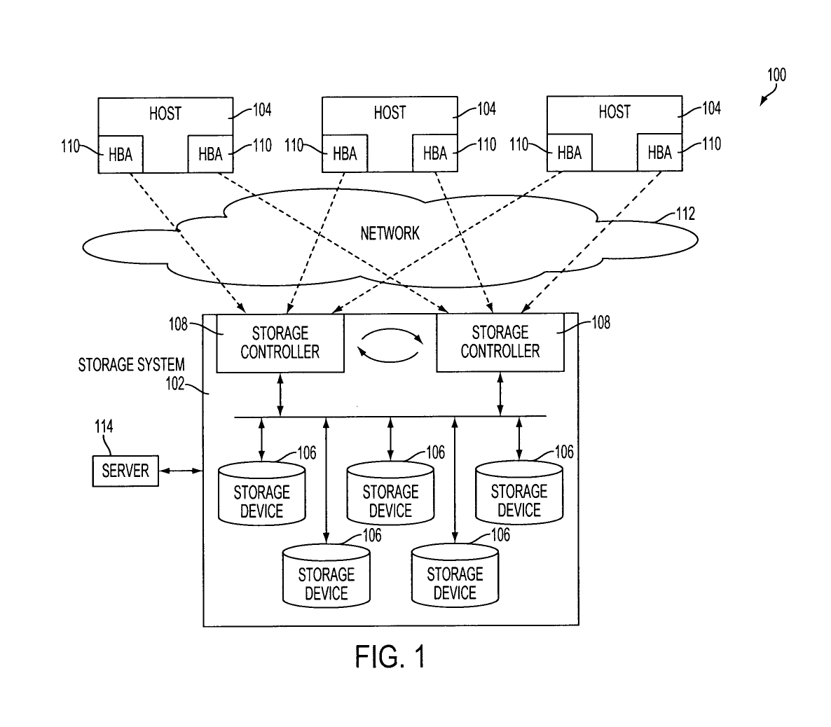

A data storage architecture 100 is described with reference to FIG. 1. In an example, the techniques to dynamically grow and shrink the snapshot repository are performed by storage controllers 108, as described in more detail below. The storage architecture 100 includes a storage system 102 in communication with a number of hosts 104. The storage system 102 is a system that processes data transactions on behalf of other computing systems including one or more hosts, exemplified by the hosts 104. The storage system 102 may receive data transactions (e.g., requests to read and/or write data) from one or more of the hosts 104, and take an action such as reading, writing, or otherwise accessing the requested data. For many exemplary transactions, the storage system 102 returns a response such as requested data and/or a status indictor to the requesting host 104. It is understood that for clarity and ease of explanation, only a single storage system 102 is illustrated, although any number of hosts 104 may be in communication with any number of storage systems 102.

While the storage system 102 and each of the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor such as a microcontroller or a central processing unit (CPU) operable to perform various computing instructions. The instructions may, when executed by the processor, cause the processor to perform various operations described herein with the storage controllers 108 in the storage system 102 in connection with embodiments of the present disclosure. Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 and responds to one or more hosts 104's data transactions so that the storage devices 106 appear to be directly connected (local) to the hosts 104. In various examples, the storage devices 106 include hard disk drives (HDDs), solid state drives (SSDs), optical drives, and/or any other suitable volatile or non-volatile data storage medium. In some embodiments, the storage devices 106 are relatively homogeneous (e.g., having the same manufacturer, model, and/or configuration). However, it is also common for the storage system 102 to include a heterogeneous set of storage devices 106 that includes storage devices of different media types from different manufacturers with notably different performance.

The storage system 102 may group the storage devices 106 for speed and/or redundancy using a virtualization technique such as RAID (Redundant Array of Independent/Inexpensive Disks). The storage system may also arrange the storage devices 106 hierarchically for improved performance by including a large pool of relatively slow storage devices and one or more caches (i.e., smaller memory pools typically utilizing faster storage media). Portions of the address space may be mapped to the cache so that transactions directed to mapped addresses can be serviced using the cache. Accordingly, the larger and slower memory pool is accessed less frequently and in the background. In an embodiment, a storage device includes HDDs, while an associated cache includes SSDs.

In an embodiment, the storage system 102 may group the storage devices 106 using a dynamic disk pool (DDP) virtualization technique. In a DDP, volume data, protection information, and spare capacity are distributed across each of the storage devices included in the DDP. As a result, each of the storage devices in the DDP remain active, and spare capacity on any given storage device is available to each of the volumes existing in the DDP. Each storage device in the DDP is logically divided up into one or more data extents at various logical block addresses (LBAs) of the storage device. A data extent is assigned to a particular data stripe of a volume. An assigned data extent becomes a “data piece,” and each data stripe has a plurality of data pieces, for example sufficient for a desired amount of storage capacity for the volume and a desired amount of redundancy, e.g. RAID 5 or RAID 6. As a result, each data stripe appears as a mini RAID volume, and each logical volume in the DDP is typically composed of multiple data stripes. For purposes of discussion herein, data stripes may be also referred to as “stripe volumes,” “c-stripes,” and/or “d-stripes.” For example, a data piece may be a contiguous section of either 512 MB or 520 MB (depending on whether protection information is possible or not). A data stripe may be built from ten data pieces, for example, to result in approximately 4 GB of capacity per data stripe (e.g., in a RAID 6 configuration of 8 data and 2 parity data pieces).

The storage system 102 also includes one or more storage controllers 108 in communication with the storage devices 106 and any respective caches. The storage controllers 108 exercise low-level control over the storage devices 106 in order to execute (perform) data transactions on behalf of one or more of the hosts 104. The storage system 102 may also be communicatively coupled to a user display for displaying diagnostic information, application output, and/or other suitable data.

For example, the storage system 102 is communicatively coupled to server 114. The server 114 includes at least one computing system, which in turn includes a processor, for example as discussed above. The server 114 may include a general purpose computer or a special purpose computer and may be embodied, for instance, as a commodity server running a storage operating system. The computing system may also include a memory device such as one or more of those discussed above, a video controller, a network interface, and/or a user I/O interface coupled to one or more user I/O devices. While the server 114 is referred to as a singular entity, the server 114 may include any number of computing devices and may range from a single computing system to a system cluster of any size.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with a storage controller 108 of the storage system 102. The HBA 110 provides an interface for communicating with the storage controller 108, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. The HBAs 110 of the hosts 104 may be coupled to the storage system 102 by a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), a Storage Attached Network (SAN), the Internet, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., read, write, modify, etc.) remote data, a host HBA 110 sends one or more data transactions to the storage system 102. Data transactions are requests to read, write, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The storage system 102 executes the data transactions on behalf of the hosts 104 by reading, writing, or otherwise accessing data on the relevant storage devices 106. A storage system 102 may also execute data transactions based on applications running on the storage system 102 using the storage devices 106. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a Wide Area Network (WAN), and/or a Local Area Network (LAN). Fibre Channel and FCoE are well suited for embodiments where hosts 104 are coupled to the storage system 102 via a direct connection or via Fibre Channel switches. A SAN device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. It is understood that the scope of present disclosure is not limited to either block-level or file-level protocols, and in many embodiments, the storage system 102 is responsive to a number of different memory transaction protocols.

In an embodiment, the server 114 may also provide data transactions to the storage system 102. Further, the server 114 may be used to configure various aspects of the storage system 102, for example under the direction and input of a user. Some configuration aspects may include definition of RAID group(s), disk pool(s), and volume(s), to name just a few examples. In an embodiment, the server 114 may store instructions, for example in one or more memory devices. The instructions may, when executed by a processor for example in association with an application running at the server 114, cause the processor to perform one or more operations to provide the configuration information to the storage controllers 108 in the storage system 102.

The storage controller 108 (for example, one of the storage controllers 108 illustrated in FIG. 1) may receive a write command from one or more hosts 104 for a block of data to be written to a location within one of the storage devices 106 (e.g., to a logical address in a logical volume that maps to a physical address within a storage device 106). According to aspects of the present disclosure, the storage system 102 implements a copy-on-write snapshot backup regime. The backup regime may be with respect to data stored at the server 114 or alternatively to data stored on behalf of the server 114 and/or one or more hosts 104 at the storage system 102. Upon receipt of the write command the storage controller 108 may first back up the block of data of the storage device 106 (or other storage device where the data to be overwritten is located) that corresponds to the write command's target (prior to the write occurring) by taking a snapshot of the data block. The storage controller 108 may add the point in time snapshot to a snapshot image in a snapshot repository.

In an embodiment, the snapshot repository may comprise a concat stripe volume corresponding to one or more supporting storage devices 106 in a DDP. In other words, the storage controller 108 stores the snapshots to one or more storage drives 106 in the storage system 102 that have been logically arranged into a snapshot repository. In an embodiment, the snapshot repository may be associated with a particular base volume (whether local to the storage system 102 or located elsewhere). Any given base volume may have multiple snapshot repositories associated with it. In another embodiment, a given snapshot repository may have one or more base volumes associated with it.

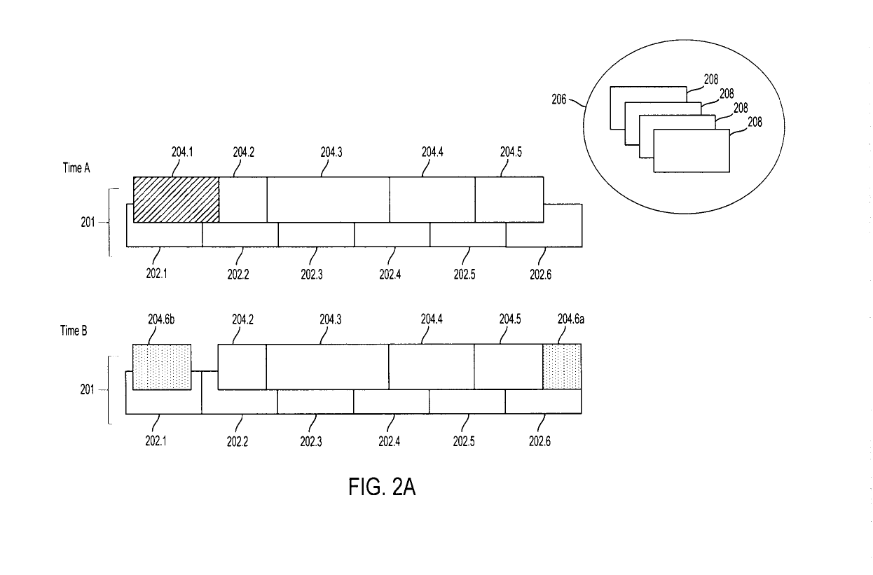

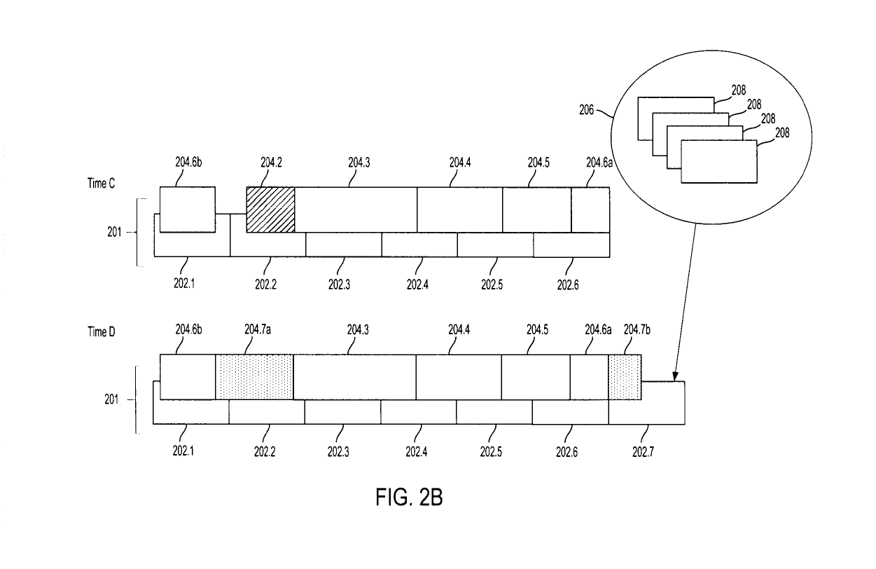

An example of a snapshot repository according to aspects of the present disclosure can be seen in FIG. 2A, which illustrates the utilization of a snapshot repository 201. The snapshot repository 201 may exist across one or more storage devices 106 of the storage controller 108 of FIG. 1. The snapshot repository 201 includes a plurality of stripe volumes 202 that, together, have an allocated capacity. For purposes of illustration, the discussion below with respect to the remaining figures will describe what occurs with respect to specific stripe volumes 202 of the snapshot repository 201. In an embodiment, in operation the storage controller 108 may maintain a running knowledge of the boundaries (e.g., LBA at the boundaries of each stripe volume 202) during operation. In another embodiment, the storage controller 108 may operate without inquiry into the boundaries between c-stripes, aside from when a snapshot image 204 is deleted. At those times, the storage controller 108 may determine the boundary of the stripe volume 202 where the deleted snapshot image 204 had been stored to determine whether the stripe volume 202 is not free for unmapping or remapping, as discussed further below with respect to the subsequent figures.

The allocated capacity describes how many physical storage device blocks are actually allocated to the snapshot repository 201. The allocated capacity is less than or equal to a virtual capacity of the snapshot repository 201, which describes the maximum LBA range of the repository. Finally, the used capacity of the snapshot repository 201 refers to the total amount of space (e.g., data blocks) from the allocated capacity that are actually storing valid data at the time (and, therefore, is less than or equal to the allocated capacity).

In FIG. 2A stripe volumes 202.1, 202.2, 202.3, 202.4, 202.5, and 202.6 are illustrated. The number of stripe volumes 202 shown in FIG. 2A is for purposes of illustration only. As will be recognized, a given snapshot repository 201 may be composed of more or fewer stripe volumes 202 without departing from the scope of the present disclosure. The snapshot repository 201 may be comprised of a concat logical volume which contains one or more stripe volumes as members (e.g., stripe volumes 202.1 through 202.6 in FIG. 2). The concat logical volume presents the one or more member stripe volumes 202 as one contiguous address space (LBA range—the virtual capacity) of the snapshot repository 201 to the storage controller 108.

In an embodiment, a minimum number of stripe volumes 202 may be specified according to need or desire to arrive at the allocated capacity. In the example shown in FIG. 2A, the stripe volumes 202.1 through 202.6 are in accordance with a minimum number of six stripe volumes 202, to name just one example. In an embodiment, the lowest LBA (also referred to as a starting LBA) may be associated with the stripe volume 202.1 and incrementally increase to the highest LBA (also referred to as an ending LBA) that may be associated with the stripe volume 202.6 in FIG. 2A.

Also shown in FIG. 2A is a pool 206 of available stripe volumes 208. In an embodiment, the available stripe volumes 208 have been pre-initialized to reduce time and latency burdens on the storage controller 108 of FIG. 1. The snapshot repository 201 may store one or more snapshot images 204. As shown, a snapshot image 204.1 is sufficiently large that it occupies the available LBA range of the stripe volume 202.1 as well as a portion of the stripe volume 202.2. Contiguous to the snapshot image 204.1 is snapshot image 204.2, and so on through snapshot image 204.5. Each snapshot image 204 may start at a LBA immediately after the ending LBA of the previous snapshot image 204. Together, these snapshot images 204 constitute the used capacity of the repository. FIG. 2A illustrates the snapshot repository 201 at time A after multiple snapshot images 204 have already been stored. In an embodiment, a minimum number of snapshot images 204 may be specified to be maintained at the snapshot repository 201 at any given time, for example five to name just one example. Thus, whenever additional snapshot images 204 begin, the oldest snapshot image 204 may be deleted from the snapshot repository 201 to make space for the newest image. This may also be referred to as the oldest snapshot images 204 “aging out” over time.

This is illustrated at time A with respect to snapshot image 204.1. As the oldest image in the snapshot repository, snapshot image 204.1 becomes eligible for deletion once snapshot image 204.5 is done and a new snapshot image (which will be snapshot image 204.6 in FIG. 2A) is beginning. When it is time for snapshot image 204.6 to begin, snapshot image 204.1 is deleted. When a new snapshot image 204 begins, the storage controller 108 looks at the remaining virtual capacity (available LBA space) of the snapshot repository 201. If there is sufficient capacity at the current LBA to store at least some data, the storage controller 108 causes the next snapshot image 204 to start at that location.

As the snapshot repository 201 fills up with snapshot images 204, it may become necessary to find or create available space (ranges of LBA that are available for data) so that any older snapshot images 204 may be preserved (instead of being overwritten by data in a new snapshot image). This scenario is present in FIG. 2A.

According to embodiments of the present disclosure, when starting a new snapshot image 204.6 (and at approximately the same time deleting the snapshot image 204.1), the storage controller 108 may determine whether there is sufficient capacity (range of available LBAs) at the current stripe volume, here stripe volume 202.6. This may occur at the time the snapshot image 204 begins, or alternatively may occur at approximately the same time as the data being stored reaches the ending LBA of the snapshot repository 201's virtual capacity. As part of this determination, the storage controller 108 may look to whether there is another stripe volume 202 concatenated at the end of the current stripe volume 202, for example as will be discussed in more detail below with respect to FIG. 2B. If there is not, the storage controller 108 may look to whether a range of LBAs at the start of the snapshot repository 201's virtual capacity are available (e.g., do not have a snapshot image 204 still actively stored there). Depending on the result, the storage controller 108 may determine to either wrap the current snapshot image 204 to the start of the LBA range (FIG. 2A) or to add an available stripe volume 208 from the pool 206 (FIG. 2B).

In FIG. 2A, at time B data is being stored to the snapshot image 204.6 at the end of the LBA range of the snapshot repository. As this reaches the end of the LBA range, the storage controller 108 determines that, since snapshot image 204.1 has aged out, there is a range of LBAs now available at the start of the snapshot repository 201 on stripe volume 202.1. As a result, the storage controller 108 splits the snapshot image 204.6 between the end of the LBA range on volume 202.6 and the start of the LBA range on volume 202.1, illustrated as snapshot image parts 204.6a and 204.6b. As can be seen, the snapshot repository 201 may also be viewed as a type of unique circular queue where the corresponding LBA ranges are available.

Turning now to FIG. 2B, at a later time C the snapshot image 204.6 has completed storage as wrapped between snapshot image part 204.6a at the end of the LBA range and snapshot image part 204.6b at the start of the LBA range. When beginning a new snapshot image 204.7, the storage controller 108 again “ages out” the oldest remaining snapshot image 204, here at time C snapshot image 204.2. As a result, additional space becomes available on stripe volume 202.2 contiguous to the stripe volume 202.1 where the current LBA being written to is located.

At time D, with the now-oldest snapshot image 204.2 deleted, the storage controller 108 begins directing backup data to the current snapshot image 204.7 at the LBA location on the stripe volume 202.1 near the beginning of the LBA range. As the snapshot image 204.7 grows with data, the storage controller 108 watches for a condition where the available storage space runs into space still being occupied by another snapshot image, here snapshot image 204.3 on the stripe volume 202.2. Since it is undesirable to overwrite the data associated with the snapshot image 204.3, which is being maintained according to a specified minimum number of snapshot images, the storage controller 108 responds to this condition by growing the snapshot repository 201. This growth results in an increase in both the virtual capacity (LBA range) and allocated capacity (stripe volume allocated to the LBA range).

As illustrated in FIG. 2B at time D, when the size of the current snapshot image 204.7 grows to occupy all of the currently available space at the current LBA location, the storage controller 108 recognizes the condition. In response, the storage controller 108 dynamically grows the snapshot repository 201's virtual and allocated capacities by pulling an available stripe volume 208 from the pool 206 and concatenating the stripe volume 208 to the end of the snapshot repository 201. In an embodiment, the concatenated stripe volume 208, now stripe volume 202.7 of the snapshot repository 201, assumes the next contiguous LBA to the ending LBA of the stripe volume 202.6, which is a new range of LBAs added. This type of growth of the snapshot repository 201 is the alternative option available when the start of the LBA range is not available, as indicated with respect to FIG. 2A above.

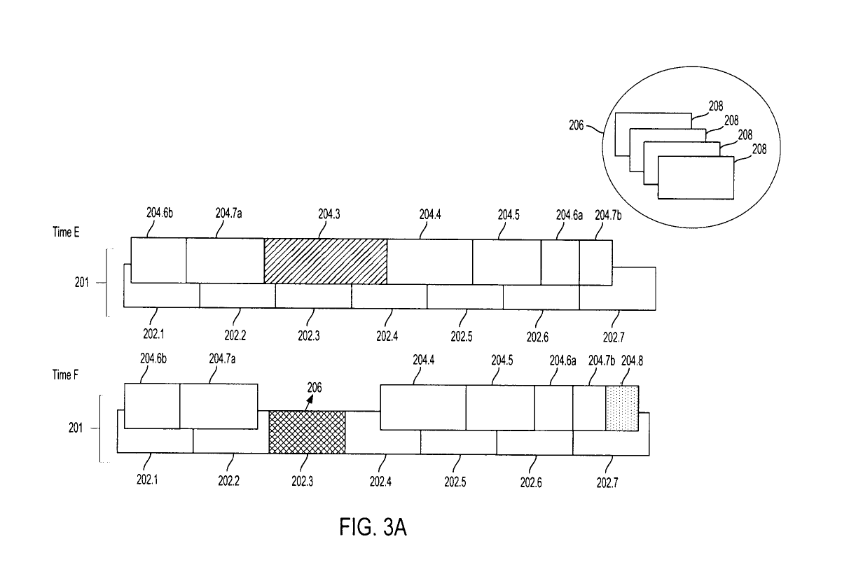

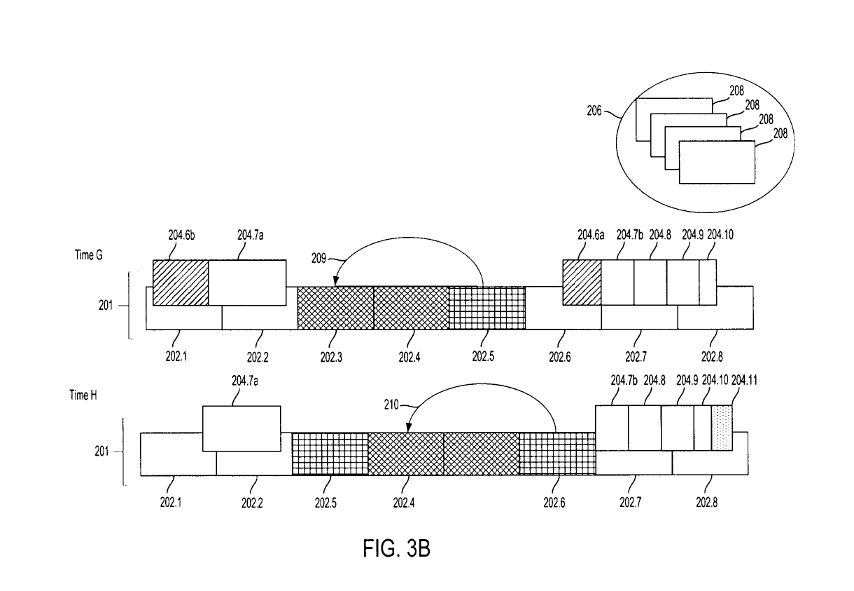

Although illustrated as being associated with an LBA range at the end of the current LBA range of the snapshot repository, in an additional or alternative embodiment the growth of the snapshot image 204.7 may reach the end of an LBA range that is currently associated with a stripe volume 202 (sometimes referred to as being “mapped” to the LBA range) that is adjacent to an unmapped LBA range. For example, as will be discussed in more detail below with respect to FIG. 3A, stripe volumes 202 that currently do not have active snapshot images 204 (e.g., because images that were stored aged out and were deleted) may be unmapped (dis-associated from their particular LBA range in the snapshot repository) from the snapshot repository 201 and returned to the pool 206 of available stripe volumes 208. In these situations, the storage controller 108 may pull an available stripe volume 208 and associate it with the LBA range contiguous to the active LBA range of the snapshot image 204.7. As a result, the allocated capacity would change (with the new stripe volume) but the overall virtual capacity would not change. If no stripe volumes 208 are available at the time (under either embodiment), the next oldest snapshot image (here, 204.3) may be deleted or an error returned, depending upon the policy set.

Returning to the situation specifically illustrated in FIG. 2B, after adding the stripe volume 202.7 the storage controller 108 may split the active snapshot image 204.7 between the current location at stripe volume 202.2 as snapshot image part 204.7a and the newly-available LBA range at the stripe volume 202.7 as snapshot image part 204.7b, similar in effect to the wrapping action described previously with respect to FIG. 2A. The storage controller 108 may thereafter continue writing data to the new LBA range associated with the stripe volume 202.7 until the current snapshot image period ends.

In an embodiment, there may be a maximum expansion size that is previously set, either automatically by the storage controller 108 or by a user elsewhere. This enables a user to control how much allocated capacity any given snapshot repository can take from the pool 206. In an embodiment, the next oldest snapshot image may be deleted or an error returned, even where one or more stripe volumes 208 are still available in the pool, where the number of stripe volumes 202 in the snapshot repository 201 is at the maximum expansion size. In an embodiment, the pool 206 may be overprovisioned so that the maximum expansion size of the repositories with access to the pool 206 may amount to more stripe volumes than are available in the pool 206. Further, the size of the pool 206 may be set to maintain a level of control over how much total storage capacity of the storage system 102 is allocated to snapshot repositories. In embodiments where the pool 206 is overprovisioned, a user or the storage controller 108 may establish different priorities for different snapshot repositories, for example by increasing the specified minimum size for a given snapshot repository (the minimum number of stripe volumes that should be associated with the repository). This effectively assigns that snapshot repository a higher priority than other repositories with smaller minimum sizes, since more stripe volumes remain associated with the larger repository regardless of actual used capacity. As another example, the user or the storage controller 108 may decrease the priority of a given snapshot repository by decreasing the specified minimum size for the given snapshot repository. This effectively assigns the given snapshot repository a lower priority than other repositories with larger minimum sizes, since fewer stripe volumes remain associated with the given snapshot repository.

Turning now to FIG. 3A, an organizational diagram is shown that illustrates the treatment of specific volumes of a snapshot repository 201 according to aspects of the present disclosure. Continuing with the example of FIGS. 2A and 2B above, after time D comes a later time E in FIG. 3A. At time E, the snapshot image 204.7 has completed storage as split between snapshot image part 204.7a near the start of the LBA range and snapshot image part 204.7b at the newly-added (e.g., extended or re-associated, where the repository was previously trimmed) LBA range. When beginning a new snapshot image 204.8 at the current LBA at stripe volume 202.7, the storage controller 108 again ages out the oldest snapshot image 204, now snapshot image 204.3 as illustrated at time E of FIG. 3A. As a result, space now becomes available at the LBA range where snapshot image 204.3 was stored, here spanning stripe volumes 202.2, 202.3, and a portion of 202.4.

At time F, with the oldest snapshot image 204.3 deleted, the stripe volume 202.3 is now free from any snapshot images, since the current snapshot image 204.8 began storage at the next contiguous LBA to the end of the snapshot image 204.7b at the stripe volume 202.7. The storage controller 108 may recognize that the stripe volume 202.3 is no longer storing any snapshot images 204 and compare the current number of stripe volumes 202 to the desired minimum number of stripe volumes 202 (e.g., here six stripe volumes 202). If the storage controller 108 determines that the current number exceeds the minimum, the storage controller 108 may remove the stripe volume 202.3 (e.g., by unmapping the corresponding LBA range from the stripe volume 202.3) and return the stripe volume 202.3 to the pool 206 of available volumes 208, as illustrated in FIG. 3A. In an embodiment, the storage controller 108 avoids unmapping the first stripe volume 202.1 of the snapshot repository 201 in order to preserve valid header data stored there.

FIG. 3B illustrates an organizational diagram that shows the treatment of specific volumes of a snapshot repository 201 according to aspects of the present disclosure. Continuing with the example of FIGS. 2A, 2B, and 3A above, after time F comes a later time G in FIG. 3B. Sufficient time has passed at time G that, in this example, snapshot images 204.4 and 204.5 already aged out and new snapshot images 204.9 and 204.10 have started and finished. Because the starting range of LBAs at stripe volume 202.1 was not available while the snapshot images 204.9 or 204.10 were actively storing data, the storage controller 108 accessed another available stripe volume 208 and associated it at the end of the existing LBA range as stripe volume 202.8 as described above with respect to FIG. 2B. As a result, the snapshot repository 201 again has grown its virtual capacity.

With the aging out of snapshot images 204.4 and 204.5, the underlying stripe volumes 202.4 and 202.5 no longer have snapshot image data on them. Stripe volume 202.4 is unmapped from the associated LBA range and returned to the pool 206. Storage controller 108 determines, however, that unmapping the stripe volume 202.5 would reduce the total number of stripe volumes 202 to below the specified minimum, and therefore does not unmap the stripe volume 202.5 and return it to the pool 206. Instead, the storage controller 108 remaps 209 the stripe volume 202.5 to the LBA range previously associated with the stripe volume 202.3, contiguous to the still-active stripe volume 202.2 (currently storing snap image 204.7a). Thus, in the particular example of FIG. 3B, the allocated capacity has not grown along with the virtual capacity because the number of stripe volumes 202 is again at the specified minimum.

Now, at time G, the snapshot image 204.10 has completed storage and a new snapshot image 204.11 is beginning. When beginning the new snapshot image 204.11 at the current LBA at stripe volume 202.8, the storage controller 108 again ages out the oldest snapshot image 204, now snapshot image 204.6 as illustrated at time G of FIG. 3B. As a result, space now becomes available at the LBA range where snapshot image 204.6 was stored (here snapshot image parts 204.6a at the range associated with stripe volume 202.6 and 204.6b at the starting LBA range), leaving the starting LBA range associated with the stripe volume 202.1 free and stripe volume 202.6 empty of any active snapshot images 204.

At time H, although stripe volume 202.6 is a candidate for unmapping the storage controller 108 determines that unmapping stripe volume 202.6 would result in the total number of stripe volumes falling below the specified minimum. The storage controller 108 therefore does not unmap the stripe volume 202.6 and return it to the pool 206 as was discussed with respect to stripe volume 202.5 above. Instead, the storage controller remaps 210 the stripe volume 202.6 to the LBA range previously associated with the stripe volume 202.4, contiguous to what is now shown as stripe volume 202.5 in FIG. 3B at time H (another remapped volume). This may occur concurrently to the growth of snapshot image 204.11 during time H. With the remapping in FIG. 3B, neither the virtual capacity nor the allocated capacity decrease, but rather just change where the capacity is allocated with respect to the LBA range of the snapshot repository 201.

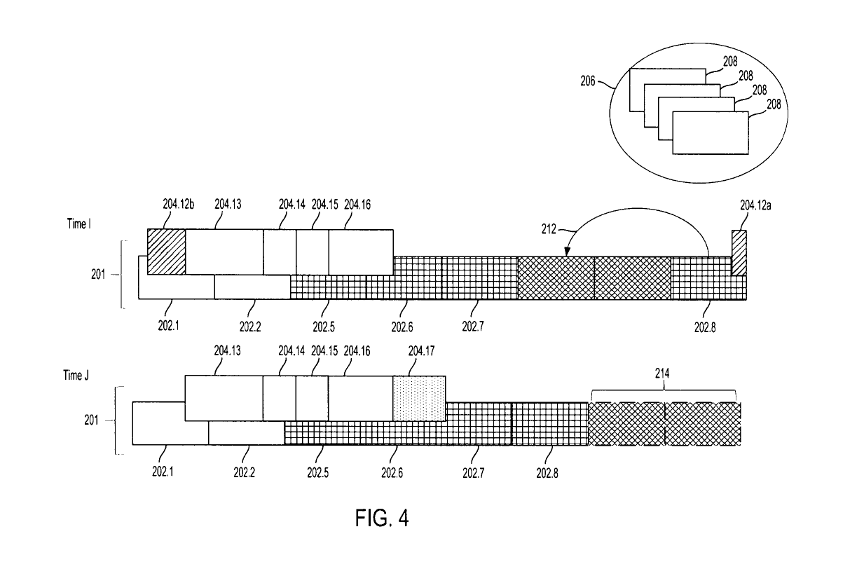

Turning now to FIG. 4, an organization diagram is illustrated that demonstrates the shrinking of a snapshot repository 201 according to aspects of the present disclosure. Continuing with the example of FIGS. 2A, 2B, 3A, and 3B above, after time H comes a later time I in FIG. 4. Sufficient time has passed at time I that, in this example, snapshot images 204.7 through 204.11 have already aged out and new snapshot images 204.12 through 204.16 have started and finished. Along with that, the storage controller 108 also remapped the stripe volume 202.7 to the next available LBA range contiguous to the stripe volume 202.6. Upon deletion of the snapshot image page 202.12a, the storage controller 108 remaps 212 the stripe volume 202.8 to the next available LBA range contiguous to the stripe volume 202.7. The storage controller 108 does this, instead of releasing the stripe volume 202.8 to the pool 206, so that the specified minimum number of stripe volumes 202 may remain associated with the snapshot repository 201.

Because the starting range of LBAs at stripe volume 202.1 became available after deletion of the snapshot image part 204.6b as shown in FIG. 3B, the storage controller 108 wrapped the active snapshot image, here 204.12, from the ending LBA to the starting LBA in similar manner as was discussed above with respect to FIG. 2A. As a result, the snapshot repository 201 again has circled back to the beginning LBA range of the snapshot repository 201, thereby avoiding the need to obtain another stripe volume 208 from the pool 206.

In FIG. 4, at time I the snapshot image 204.12 is aging out at the beginning of snapshot image 204.17. At time J, the storage controller 108 stores data to the active snapshot image 204.17, which is located at the next contiguous LBA to the snapshot image 204.16 associated with remapped stripe volume 202.6. As can be seen in FIG. 4, there are now no active snapshot images 204 stored at the end of the snapshot repository 201 (at the upper LBA range of the snapshot repository 201's virtual capacity). Upon determining this, the storage controller 108 may initiate a trim operation 214, for example by calling an application programming interface (API) function. The trim operation 214 functions to reduce the last LBA of the volume's virtual capacity to the last LBA at the end of the last allocated stripe volume, in FIG. 4 stripe volume 202.8, since the previously associated allocated capacity has already been unmapped and released to the pool 206 or remapped to lower LBA ranges of the repository.

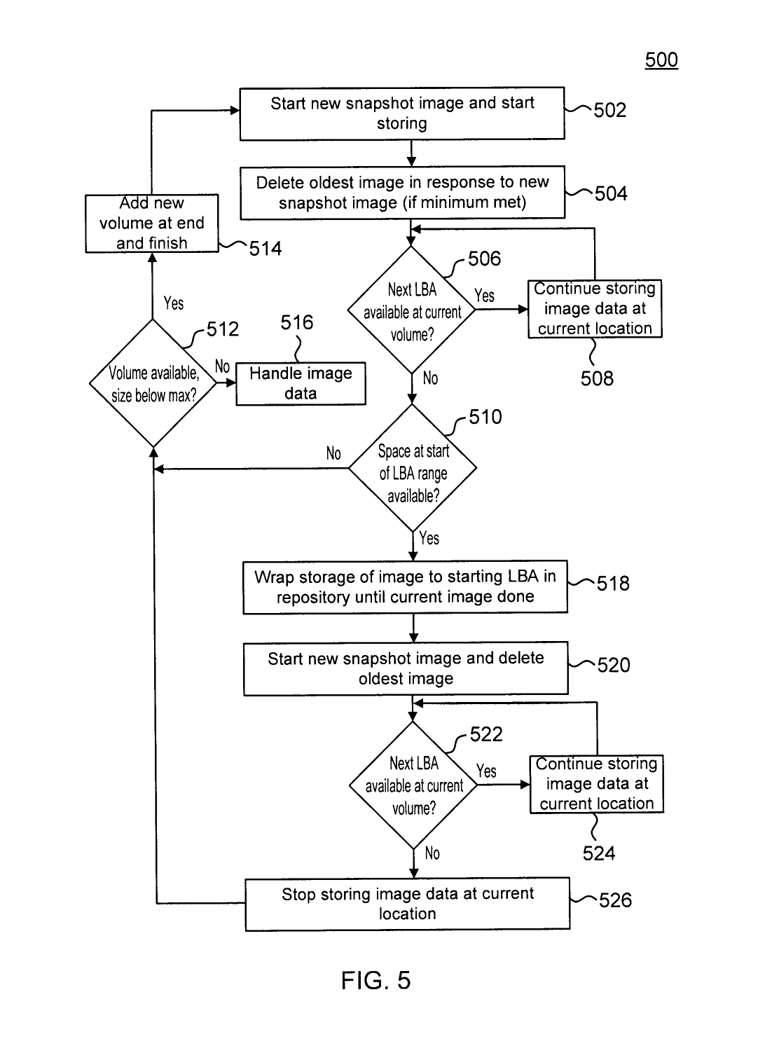

FIG. 5 is a flow diagram of a method 500 of providing a snapshot repository according to aspects of the present disclosure. In an embodiment, the method 500 may be implemented by the storage controller 108 executing computer-readable instructions to perform the functions described herein in cooperation the rest of the storage system 102. It is understood that additional steps can be provided before, during, and after the steps of method 500, and that some of the steps described can be replaced or eliminated for other embodiments of the method 500.

At block 502, the storage controller 108 starts a new snapshot image at a snapshot repository. This may be, for example, a snapshot image 204 in the snapshot repository 201 as discussed in the examples above. With the new snapshot image started, the storage controller 108 begins storing any backup data that is sent to it as part of the new snapshot image.

At block 504, the storage controller 108 deletes the oldest snapshot image stored in the snapshot repository approximately concurrently with the start of the new snapshot image. The storage controller 108 does so after checking whether a desired minimum number of snapshot images are already maintained, and that deletion of the oldest snapshot image would not cause the total number of snapshot images to fall below this minimum number. If the minimum number is not met, the storage controller 108 does not delete the oldest snapshot image. Otherwise, the oldest snapshot image is deleted.

At decision block 506, the storage controller 108 determines whether the next LBA to the current LBA location of the current stripe volume is available (i.e., does not contain active data, is not the end of the virtual capacity, or a region where a stripe volume has been unmapped). If available, then the method 500 proceeds to block 508, where the storage controller 108 stores image data at the next LBA. The method 500 then proceeds back to decision block 506 to make the determination of block 506 again for subsequent LBAs.

If the next LBA is not available, then the method 500 proceeds to decision block 510, where the storage controller 108 determines whether the LBAs at the start of the LBA range (the start of the virtual capacity of the repository) are available.

If the LBAs at the start of the repository are not available (they have a snapshot image stored there already, for example), then the method 500 proceeds to decision block 512. At decision block 512, the storage controller 108 determines whether there are stripe volumes still available in the pool of available volumes (e.g., stripe volumes 208 in pool 206). The storage controller 108 further determines whether the current size of the snapshot repository has reached a specified maximum yet. In an embodiment, the specified maximum corresponds to a maximum number of stripe volumes to be associated with the snapshot repository at a given time. In another embodiment, the specified maximum corresponds to a maximum LBA range, to name just a few examples.

If both of these conditions are met, then the method 500 proceeds to block 514. At block 514, the storage controller 108 pulls a new stripe volume from a pool of available volumes and concatenates it to the end of the current stripe volume. In an embodiment, the stripe volumes in the pool are already initialized to reduce latency and load on the system.

In an embodiment, the current stripe volume is at the end of the repository, such that additional of the new stripe volume coincides with an increase of the virtual capacity of the repository. In another embodiment, the current stripe volume is somewhere at or near the middle of the repository (e.g., the starting stripe volume or some volume that has stripe volumes adjacent to it in the lower LBA direction and adjacent to an unmapped region of LBAs in the higher LBA direction), such that addition of the new stripe volume constitutes an association of the new stripe volume with the previously unmapped range of LBAs adjacent to the current LBA location.

As part of block 514, the storage controller 108 then continues storing image data to the LBAs associated with the newly-associated stripe volume and completes the current snapshot image. The method 500 then returns to block 502 and proceeds as described above and in more detail below.

Returning to decision block 512, if either of these conditions is not met (or both), then the method 500 proceeds to block 516. At block 516, the storage controller 108 handles the new image data as it comes in by either overwriting an existing snapshot image (e.g. the oldest snapshot image) or by returning an error.

Returning to decision block 510, if the LBAs at the start of the repository are available, then the method 500 proceeds to block 518. At block 518, the storage controller 108 wraps storage of the snapshot image data between the end of the snapshot repository and the starting LBAs of the snapshot repository. As a result, a first portion of the snapshot image is stored at the current volume until it runs out of space, at which point the storage controller 108 starts with the starting LBA of the repository to continue storing data until the current snapshot image is done.

The method 500 then continues to block 520, where the storage controller 108 starts another new snapshot image and deletes the oldest snapshot image stored in the snapshot repository approximately concurrently with the start of the new snapshot image.

At decision block 522, the storage controller 108 determines whether at the next LBA to the current LBA location of the current stripe volume is available (does not contain active data, and is mapped to a stripe volume, for example). If available, then the method 500 proceeds to block 524 where the storage controller 108 continues storing image data for the current snapshot image at the LBA. The method 500 then proceeds back to decision block 522 to make the determination of block 522 again for subsequent LBAs.

If the next LBA is not available, then the method 500 proceeds to block 526, where the storage controller 108 stops storing snapshot image data at the current LBA location of the current stripe volume, which may result in a first portion of the image data being stored at the current LBA location.

The method 500 then proceeds to decision block 512 and proceeds as discussed above. Where the method 500 proceeds to block 514 from decision block 512, the storage controller 108 may split storage of the snapshot image data between the space that had been available at the current LBA location of the current stripe volume and the newly concatenated stripe volume at the end of the repository.

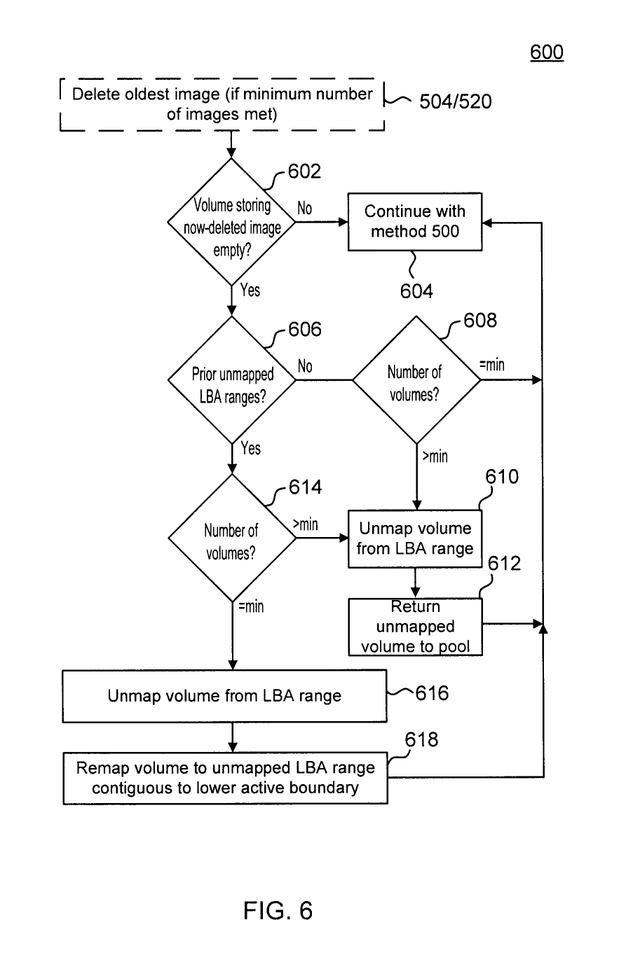

FIG. 6 is a flow diagram of a method 600 of handling specific volumes of an elastic snapshot repository according to aspects of the present disclosure. In an embodiment, the method 600 is associated with the method 500 as discussed in more detail below. The method 600 may be implemented by the storage controller 108 executing computer-readable instructions to perform the functions described herein in cooperation the rest of the storage system 102. It is understood that additional steps can be provided before, during, and after the steps of method 600, and that some of the steps described can be replaced or eliminated for other embodiments of the method 600.

The method 600 may occur after one or both of blocks 504/516 of method 500, where deletion of the oldest snapshot image occurs, as described above. At decision block 602, after deletion of the snapshot image the storage controller 108 checks whether the stripe volume where the now-deleted snapshot image was stored is now empty, with no other snapshot images stored thereon. If the stripe volume is not empty, then the method 600 proceeds to block 604, where the storage controller 108 continues with the method 500 (e.g. at blocks 506 or 518).

If the stripe volume is empty, then the method 600 proceeds to decision block 606, where the storage controller 108 determines whether any stripe volumes associated with lower LBA ranges have been unmapped previously. If not, then the method proceeds to decision block 608.

At decision block 608, the storage controller 108 looks at the number of stripe volumes currently mapped to LBA ranges of the snapshot repository to determine whether the number of stripe volumes is greater than or equal to the specified minimum number. If the number of stripe volumes is equal to the minimum number, then the method 600 proceeds back to block 604 and the method 500 continues.

If the number of volumes is greater than the minimum number, then the method 600 proceeds to block 610. At block 610, the storage controller 108 removes the now-empty stripe volume, for example by unmapping the corresponding LBA range from the now-empty stripe volume.

At block 612, the storage controller returns the removed stripe volume to a pool of available stripe volumes for use by any snapshot repository that has access to the pool.

Returning to decision block 606, if the storage controller 108 determines that there are lower LBA ranges whose associated stripe volumes have been unmapped, then the method proceeds to decision block 614. At decision block 614, the storage controller 108 looks at the number of stripe volumes currently mapped to LBA ranges of the snapshot repository to determine whether the number of stripe volumes is greater than or equal to the specified minimum number. If the number of stripe volumes is greater than the minimum number, then the method 600 proceeds to block 610 and proceeds as described above.

If the number of stripe volumes is equal to the minimum number, then the method 600 proceeds to block 616. At block 616, the storage controller 108 unmaps the now-empty stripe volume but does not release it back to the pool.

Instead, at block 618 the storage controller 108 remaps the unmapped stripe volume to a lower LBA range that is contiguous to the lower active boundary of the snapshot repository (e.g., to the lowest range of LBAs that are not currently associated with any stripe volume but are adjacent to a range of LBAs associated with a stripe volume). Once the stripe volume has been remapped, the method 600 may return to block 604 and proceed as described above with respect to FIG. 5.

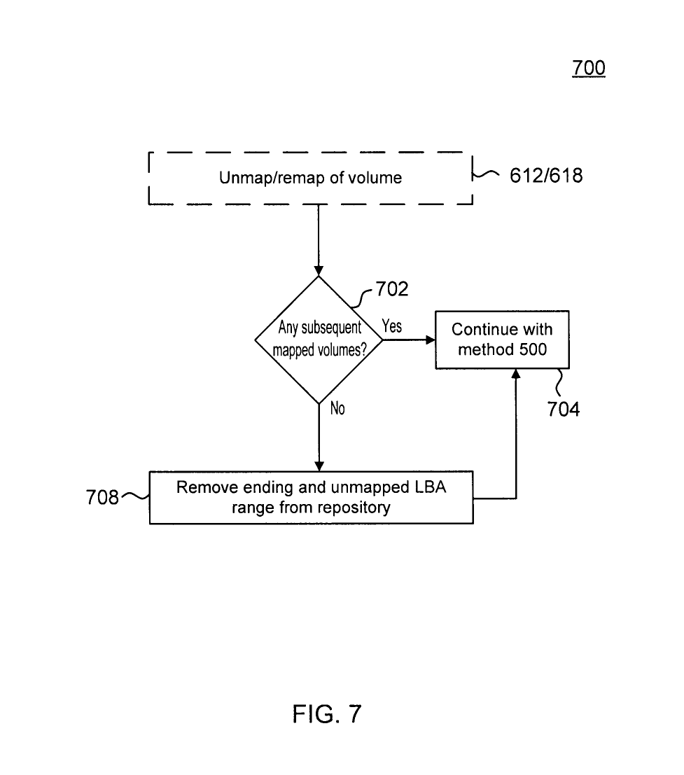

FIG. 7 is a flow diagram of a method 700 of shrinking an elastic snapshot repository according to aspects of the present disclosure. In an embodiment, the method 700 is associated with the method 600 as discussed in more detail below. The method 700 may be implemented by the storage controller 108 executing computer-readable instructions to perform the functions described herein in cooperation the rest of the storage system 102. It is understood that additional steps can be provided before, during, and after the steps of method 700, and that some of the steps described can be replaced or eliminated for other embodiments of the method 700.

The method 700 may occur after one or both of blocks 612/618 of method 600, where deletion of the oldest snapshot image occurs, as described above. At decision block 702, after the stripe volume has been unmapped or remapped (depending upon the specific situation), the storage controller 108 checks whether there are any subsequent stripe volumes at higher LBA ranges than the now-unmapped/remapped stripe volume. If there are one or more subsequent stripe volumes that are still mapped to a higher LBA range, then the method 700 proceeds to block 704, where the storage controller 108 continues with the method 500 (e.g. at blocks 506 or 518).

If, instead, there are no more subsequent stripe volumes that are still mapped to a higher LBA range, then the method 700 proceeds to block 706, where the storage controller 108 trims the unmapped LBAs after the highest mapped LBA range from the snapshot repository. In an embodiment, this may involve calling an API associated with the DDP in order to reduce the last LBA of the snapshot repository to the end of the last allocated stripe volume. This decreases the virtual capacity of the snapshot repository.

The method 700 then returns to block 704 and continues with method 500 as discussed above.

As a result, according to embodiments of the present disclosure a copy-on-write snapshot repository in a DDP may dynamically grow, shift allocated stripe volumes, and shrink to address the varying demands of a system over time while reducing latency and minimizing impact on performance of the system. This results in improved operation for the storage system 102 based on more efficient operation (e.g., processor utilization) as well as efficient use of existing storage capacity.

The present embodiments can take the form of an entirely hardware embodiment, an entirely software embodiment, or an embodiment containing both hardware and software elements. In that regard, in some embodiments, the computing system is programmable and is programmed to execute processes including those associated with providing an elastic snapshot repository such as the processes of methods 500, 600, and/or 700 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and Random Access Memory (RAM).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
receiving image data of a base volume as part of a current snapshot image in a snapshot repository;
storing a first portion of the received image data at a current logical block address (LBA) of the snapshot repository that is contiguous to a highest used LBA of the snapshot repository;
determining, as part of the storing, whether a next LBA is available to store a second portion of the received image data; and
storing the second portion of the received image data of the current snapshot image to available space at a starting LBA range of the snapshot repository in response to determining that the next LBA is not available and that the starting LBA range is available.

2. The method of claim 1, further comprising:
concatenating a new stripe volume from a pool of available stripe volumes to a current stripe volume associated with the current LBA in the snapshot repository in response to determining that the next LBA is not available and that the starting LBA range is not available; and
storing the second portion of the received image data of the current snapshot image to the new stripe volume.

3. The method of claim 1, wherein the snapshot repository comprises a plurality of snapshot images, the method further comprising:
deleting a first snapshot image from among the plurality of snapshot images stored at the starting LBA in response to starting the current snapshot image,
wherein the deleting renders at least a starting portion of the starting LBA range available for at least the second portion of the received image data.

4. The method of claim 1, further comprising:
deleting, in response to starting a new snapshot image, a second snapshot image;
determining whether any other images are stored on a stripe volume associated with an LBA range used to store the second snapshot image;
unmapping the stripe volume used to store the deleted second snapshot image in response to the deleting and determining that no other images are stored on the second stripe volume; and
releasing the unmapped stripe volume back to a pool of available stripe volumes.

5. The method of claim 4, wherein the snapshot repository comprises a subsequent stripe volume, the method further comprising:
remapping the subsequent stripe volume to the LBA range previously associated with the unmapped stripe volume in response to the unmapping.

6. The method of claim 1, further comprising:
receiving new image data as part of a new snapshot image;
storing a first portion of the new image data at an intermediate LBA range contiguous to a used LBA range of the starting LBA range; and
storing a second portion of the new image data to a new LBA range associated with an additional stripe volume concatenated to the current stripe volume in response to determining that there is not sufficient space to continue storing the new image data at the intermediate LBA range.

7. The method of claim 1, further comprising:
comparing the highest used LBA to a first total LBA capacity of the snapshot repository; and
trimming the first total LBA capacity to a second total LBA capacity that is greater than or equal to the highest used LBA and less than the first total LBA capacity.

8. A computing device, comprising:
a memory containing machine readable medium comprising machine executable code having stored thereon instructions for performing a method of providing a snapshot repository; and
a processor coupled to the memory, the processor configured to execute the machine executable code to:
receive image data as part of a snapshot image of a base volume for storage to a current stripe volume of a snapshot repository;
determine whether a next logical block address (LBA) contiguous to a highest used LBA of the current stripe volume is available to store a next portion of the received image data; and
store, in response to a determination that the next LBA at the current stripe volume is not available and there is available space at a starting LBA range of a first stripe volume of the snapshot repository, the next portion of the received image data to the available space at the first stripe volume.

9. The computing device of claim 8, wherein the processor is further configured to execute the machine executable code to:
concatenate an additional stripe volume from a pool of available stripe volumes to the current stripe volume in the snapshot repository in response to a determination that the next LBA at the current stripe volume is not available and the starting LBA range is not available; and
store the received image data at least partially to the additional stripe volume.

10. The computing device of claim 8, wherein the snapshot repository comprises a plurality of snapshot images, the processor being further configured to execute the machine executable code to:
delete a first snapshot image from among the plurality of snapshot images stored at the starting LBA associated with the first stripe volume in response to starting the snapshot image containing the received image data,
wherein the deletion renders at least a starting portion of the starting LBA range associated with the first stripe volume available for at least the next portion of the received image data.

11. The computing device of claim 8, wherein the processor is further configured to execute the machine executable code to:
delete, in response to a start of a new snapshot image, a second snapshot image stored at least partially on a second stripe volume associated with a second LBA range contiguous to the starting LBA range;
store new image data of the new snapshot image at least partially in a new LBA range associated with an additional stripe volume concatenated to the current stripe volume;
unmap the second stripe volume from the second LBA range in response to deletion of the second snapshot image and no other images being stored on the second stripe volume; and
release the second stripe volume back to a pool of available stripe volumes.

12. The computing device of claim 1, wherein the snapshot repository comprises a third stripe volume associated with a third LBA range that is greater than the second LBA range and less than a current LBA range associated with the current stripe volume, the processor being further configured to execute the machine executable code to:
remap the third stripe volume to the second LBA range in response to the second stripe volume being unmapped.

13. The computing device of claim 8, wherein the processor is further configured to execute the machine executable code to:
receive new image data as part of a new snapshot image;
store a first portion of the new image data at an intermediate LBA range contiguous to a used LBA range; and
store a second portion of the new image data to a new LBA range associated with an additional stripe volume concatenated to the current stripe volume in response to a determination that there is not sufficient space to continue storing the new image data at the intermediate LBA range.

14. The computing device of claim 8, wherein the processor is further configured to execute the machine executable code to:
compare the highest used LBA to a first total LBA capacity of the snapshot repository; and
trim the first total LBA capacity to a second total LBA capacity that is greater than or equal to the highest used LBA and less than the first total LBA capacity.

15. A non-transitory machine readable medium having stored thereon instructions for performing a method of providing a snapshot repository, comprising machine executable code which when executed by at least one machine, causes the machine to:
receive image data of a base volume as part of a current snapshot image for storage to a current stripe volume of a snapshot repository;
store a first portion of the received image data at a current logical block address (LBA) of the snapshot repository that is contiguous to a highest used LBA of the snapshot repository;
determine, as part of the storing, whether a next LBA contiguous to the current LBA is available to store a second portion of the received image data;
store the second portion of the received image data to available space at a starting LBA range of the snapshot repository associated with a first stripe volume, in response to a determination that the next LBA is not available and that the starting LBA range is available; and
store the received snapshot image at least partially to a new LBA range associated with an additional stripe volume concatenated to the current stripe volume from a pool of available stripe volumes in response to a determination that the starting LBA range is not available.

16. The non-transitory machine readable medium of claim 15, wherein the snapshot repository comprises a plurality of snapshot images, comprising further machine executable code that causes the machine to:
delete a first snapshot image from among the plurality of snapshot images stored at the starting LBA associated with the first stripe volume in response to receiving starting the current snapshot image,
wherein the deletion renders at least a starting portion of the starting LBA range associated with the first stripe volume available for at least the remaining portion of the received image data.

17. The non-transitory machine readable medium of claim 15, comprising further machine executable code that causes the machine to:
delete, in response to starting a new snapshot image, a second snapshot image stored at least partially on a second stripe volume associated with a second LBA range contiguous to the starting LBA range;
store new image data of the new snapshot image at least partially in the new LBA range associated with the additional stripe volume;
unmap the second stripe volume from the second LBA range in response to deletion of the second snapshot image and no other images being stored on the second stripe volume; and
release the second stripe volume back to a pool of available stripe volumes.

18. The non-transitory machine readable medium of claim 17, wherein the snapshot repository comprises a third stripe volume associated with a third LBA range that is greater than the second LBA range and less than a current LBA range associated with the current stripe volume, comprising further machine executable code that causes the machine to:
remap the third stripe volume to the second LBA range in response to the second stripe volume being unmapped.

19. The non-transitory machine readable medium of claim 15, comprising further machine executable code that causes the machine to:
receive new image data as part of a new snapshot image;
store a first portion of the new image data at an intermediate LBA range contiguous to a used LBA range; and
store a second portion of the new image data to the new LBA range associated with the additional stripe volume in response to a determination that there is not sufficient space to continue storing the new image data at the intermediate LBA range.

20. The non-transitory machine readable medium of claim 15, comprising further machine executable code that causes the machine to:
pre-allocate each stripe volume in the pool of available stripe volumes prior to assignment to any snapshot repository.
